(19) United States
(12) Patent Application Publication
(10) Pub. No.: US 2003/0017031 A1
(43) Pub. Date: Jan. 23, 2003

(54) Semiconductor apparatus for transferring workpiece with protection feature

(75) Inventor: Tsai-Pei Huang, Nantao (TW)

Correspondence Address: LOWE HAUPTMAN GILMAN & BERNER, LLP, Suite 310, 1700 Diagonal Road, Alexandria, VA, 22314, US

(73) Assignee: Macronix International Co., Ltd.,

(21) Appl. No.: 09/908,838

(22) Filed: Jul. 20, 2001

(51) Int. Cl. B65G 49/07

(52) U.S. Cl. 414/217.1

(57) ABSTRACT

In accordance with the present invention, in one embodiment, a semiconductor apparatus for transferring workpiece with protection feature is provided. The semiconductor apparatus comprises a processing tool having a movable platform for supporting a workpiece, an interface apparatus having a robotic transfer means is to transfer the workpiece between the movable platform and the interface apparatus, a sensor means is for detecting whether the movable platform is in a selected condition, and producing an output, and a control module responsive to the output is to control the robotic transfer means. If the sensor detects that the movable platform is not ready, the protection feature is activated to disable the load/unload function of the robotic transfer means of the interface apparatus to prevent damage due to improper operation.

### BACKGROUND OF THE INVENTION

1. Field of the Invention

The present invention generally relates to a semiconductor apparatus for transferring workpiece with protection feature, and more particularly to a semiconductor apparatus for protecting a processing tool and a robotic transfer apparatus with standardized mechanical interface (SMIF), which is automatically activated to disable the load/unload function of the robotic transfer apparatus if the processing tool is not in a proper operating condition.

2. Description of the Prior Art

The need for reduced cost per unit wafer processed drives the semiconductor industry continuously to search for ways to increase wafer yield and reduce production cycle time. It is well recognized that an overall increase in semiconductor wafer fabrication system productivity is achieved by ensuring a constant supply of wafers at each tool, thus, the transaction capability of the factory material handling system affecting the number of wafer carriers circulating in a factory. As the wafer size has increased, the handling of wafers has become more limited to factory automation, instead of manual handling, to accommodate the increase in size and weight of wafer pods. In other words, the transaction of an interface apparatus transferring a wafer or a wafer cassette into a processing or metrology tool becomes more and more important and complicated.

Semiconductor wafer handling and processing have always required extreme care to avoid contamination due to ambient and process-born particles. Such contamination lowers process yields, thus making the manufacture of integrated circuits more expensive and time consuming. The standardized mechanical interface (SMIF) system is developed not only to facilitate semiconductor wafer fabrication, but also to reduce particle fluxes onto semiconductor wafers during storage and transport of the wafers through the semiconductor fabrication process. A SMIF system has three main components: sealed pods used for storing and transporting wafer cassettes, a mini-environment supplied with ultra-clean air flows surrounding cassette load ports and wafer processing areas of processing stations so that the environments inside the pods and mini-environment become miniature clean spaces. Last a robotic transfer assemblies to load/unload wader cassettes and/or wafers from the sealed pods to the processing toll without contamination of the wafers in the wafer cassette from external environment. The SMIF system is therefore an effective interface between an operator and the process tool providing a continuous, ultra-clean environment for the wafers as they move through the wafer fab.

Recently, robotic apparatus and other machines having a SMIF apparatus is designed to integrate wafer cassette loading and unloading into a wafer processing and metrology tools. Thus, the operation interface is becoming more complicated. The use of safety sensors for detecting whether the interface apparatus is in a proper operating condition belongs to the control interface of the machines itself, and the complicated operation interface between the robotic apparatus and the processing tool puts a burden on an operator resulting in improper operation. For example, if the platform of the processing tool is not ready, (or not “home”) that is, not detected by the safety sensors of the robotic machine, and the operator starts the unload operation, the wafer and either the robotic machine or the processing tool can be damaged.

While lots of alarms in the control interface have been generally useful, but the aim to simplify the operation interface and to reduce the burden of the operator and preventing improper operation is continuously demanded. Thus, it is desired to provide a semiconductor apparatus for transferring workpiece to protect an interface apparatus from damage due to improper operation by a simple protection feature between the processing tool and the interface apparatus.

### SUMMARY OF THE INVENTION

The present invention is directed toward a semiconductor apparatus for transferring workpiece with protection feature, which uses the integration of a simple sensor to prevent damage due to improper operation. A semiconductor apparatus for transferring workpiece comprises a processing tool having a movable platform for supporting a workpiece, an interface apparatus having a robotic transfer means for transferring the workpiece between the processing tool and the interface apparatus, and a control module to control the robotic transfer means. The present invention uses a sensor to detect whether the movable platform of the processing tool is “home” or not, and to produce an output signal, then the signal is sent to the control module. If the sensor detects that the movable platform is not home, the protection feature is activated to disable the load/unload function of the robotic transfer means of the interface apparatus to prevent from improper operation damaging the wafer, the processing tool, and the interface apparatus.

It is another object of this invention that a semiconductor apparatus with a switch sensor are provided to indicate whether the processing tool is in a proper operating condition or not.

It is a further object of this invention that a semiconductor apparatus with protection feature, which automatically disables operations of an interface apparatus when a processing tool is not in a proper operating condition, is provided.

In accordance with the present invention, in one embodiment, a semiconductor apparatus for transferring workpiece with protection feature is provided. The semiconductor apparatus comprises a processing tool having a movable platform for supporting a workpiece, an interface apparatus having a robotic transfer means is to transfer the workpiece between the movable platform and the interface apparatus, a sensor means is for detecting whether the movable platform is in a selected condition, and producing an output, and a control module responsive to the output is to control the robotic transfer means. The interface apparatus is disabled from robotic transferring a workpiece to the movable platform when the movable platform is not in the selected position. The control module further comprises a display module for displaying the output.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic view of a semiconductor apparatus for transferring workpiece with protection feature in accordance with the present invention;

FIG. 2 is a schematic view of the circuit connection between units of a semiconductor apparatus in accordance with the present invention;

FIG. 3 is a schematic view of a semiconductor apparatus for transferring workpiece in accordance with the present invention; and

FIG. 4 is a flowchart of a semiconductor apparatus for transferring workpiece in accordance with the present invention.

### DESCRIPTION OF THE PREFERRED EMBODIMENT

Some sample embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

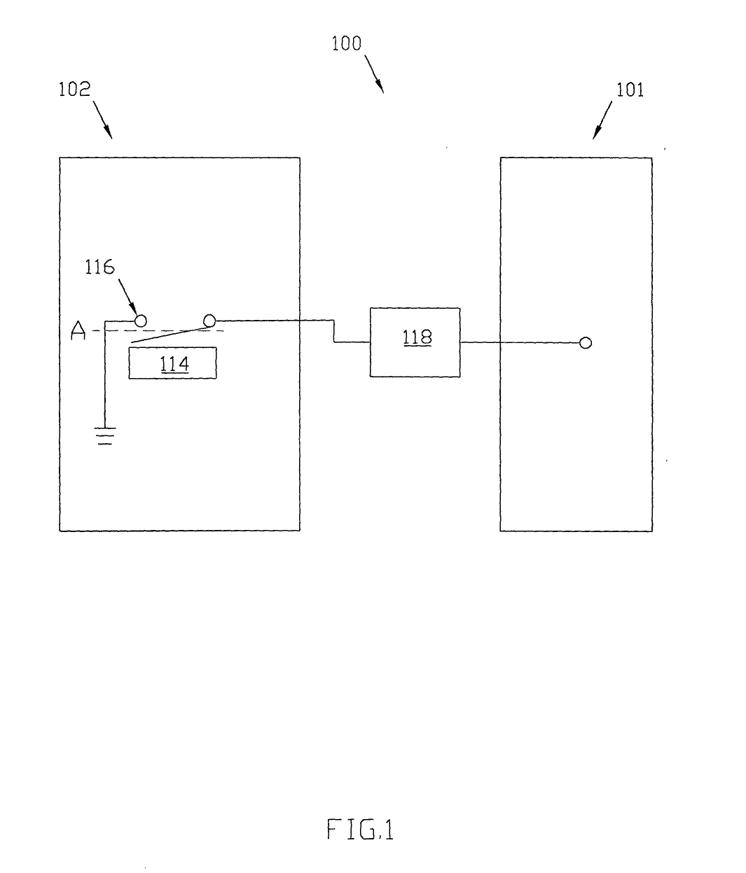

In one embodiment, in accordance with the present invention, a semiconductor apparatus for transferring workpiece with protection feature is provided. As shown in FIG. 1, which in general relates to semiconductor apparatus 100 for transferring workpiece comprising an interface apparatus 101 having a robotic transfer means for transferring a workpiece between the interface apparatus 101 and a movable platform 114 of a processing tool 102. The key aspect of the present invention is the application of a sensor means to detect if the movable platform 114 of the processing tool 102 is in a selected condition and produces an output. If the movable platform 114 moves to a position such as position A for the robotic transfer means of the interface apparatus 101 loading/unloading the workpiece 110, it is defined as “home” or “ready”. If the movable platform 114 is not at the position for the robotic transfer means of the interface apparatus 101 loading/unloading the workpiece 110, it is defined as “not home” or “not ready”. A control module 118 responsive to the output controls the robotic transfer means of the interface apparatus 101. While the interface apparatus 101 described in the present invention is respect to a SMIF system, it is understood that the present invention may be used with any of various interface apparatus for storing and transferring semiconductor wafers. The processing tool 102 can be a wafer processing or metrology tool, such as an etching tool or a surface scan tool. The term “semiconductor wafer” or “wafer” as used herein refers to a wafer substrate as it may exist in any of the various stages of the semiconductor wafer fabrication process.

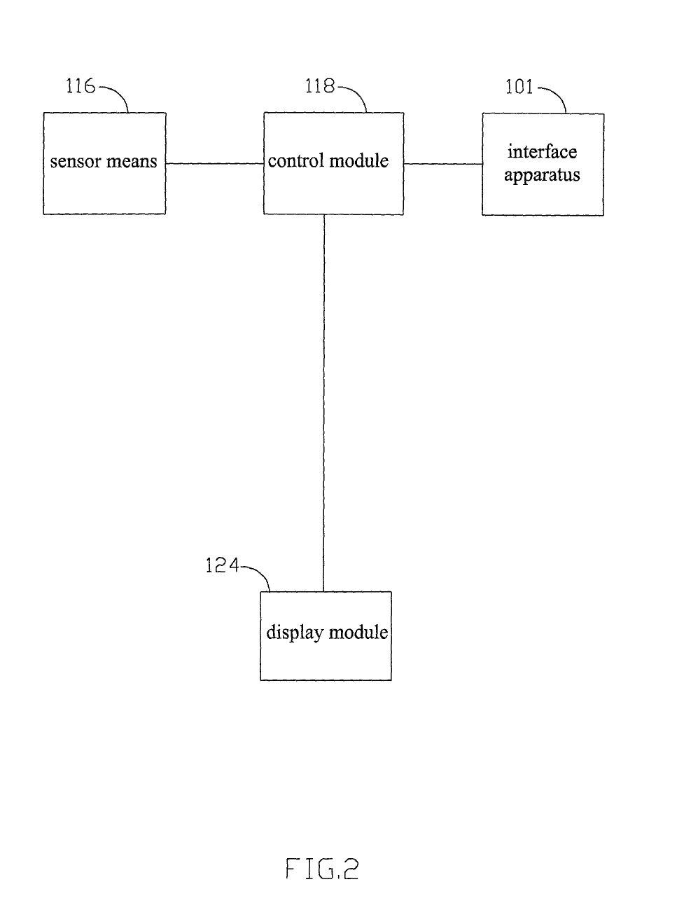

FIG. 2 illustrated a schematic circuit connection between the sensor means 116, the control module 118, the display module 124, and the interface apparatus 101 of the semiconductor apparatus 100. The sensor means 116 is used for detecting whether the movable platform 114 is in a selected position or not, such as reaching to the position A or not, and producing an output. Then, the output is sent to the control module 118, wherein the control module 118 is responsive to the output to control the robotic transfer means of the interface apparatus 101 and also to display the output on the display module 124. For example, the control module 118 disables the load/unload function of the robotic transfer means when the movable platform is not in the selected position, in other words, is not ready. The control module activates the load/unload function of the robotic transfer means when the movable platform is ready.

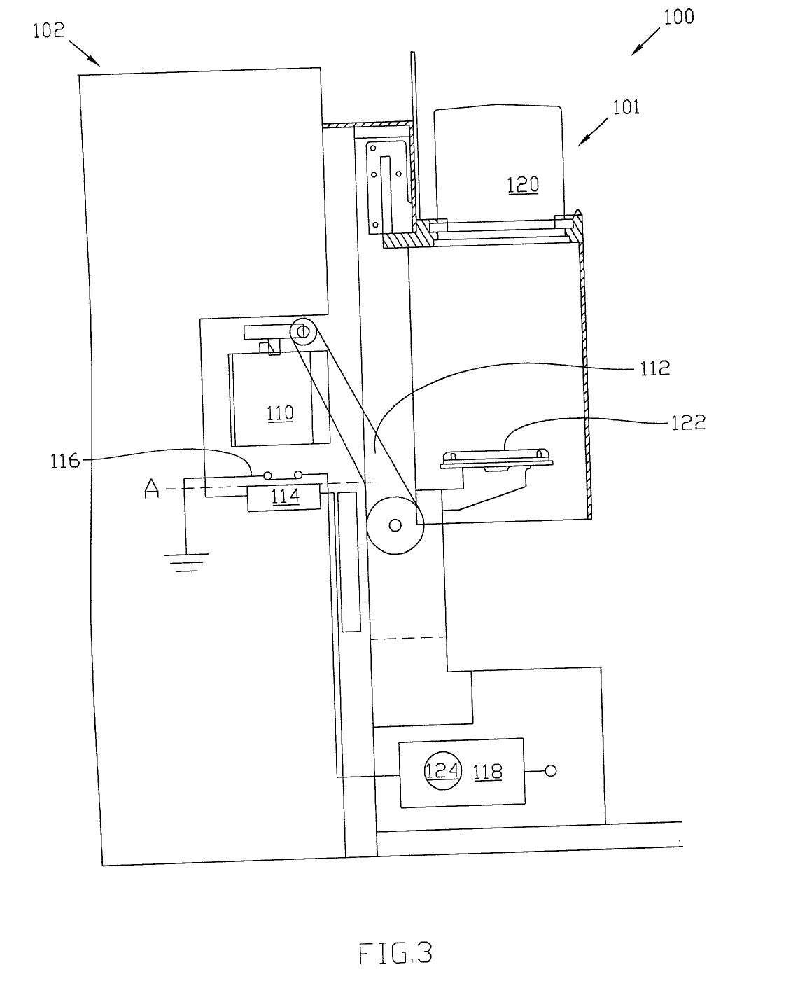

Referring to FIG. 3, in accordance with the present invention, a semiconductor apparatus with protection feature, comprises a processing tool 102 having a movable platform 114 for supporting a workpiece 110, an interface apparatus 101 having a robotic transfer means 112 is to transfer the workpiece 110 between the movable platform 114 and the interface apparatus 101, a sensor means 116 is for detecting whether the movable platform 114 is in a selected condition, and producing an output, and a control module 118 responsive to the output is to control the robotic transfer means 112. The workpiece 110 can be a semiconductor-wafer-carrying cassette including one or more semiconductor wafers or a semiconductor wafer, such as a wafer cassette in the embodiment. The movements of the movable platform 114 can be either vertical or horizontal to achieve the purpose of processing the workpiece 110 in the processing tool 102.

In the transfer process of workpiece, a pod or a SMIF pod is usually used to support the workpiece. A pod including a top 120 and a door 122 is positioned on the interface apparatus 101. The interface apparatus 101 first decouples the pod top from the pod door, and then lowers the pod door with the workpiece 110 thereon adjacent to the movable platform 114. The control module 118 responsive to the output sent by the sensor means 116 regarding the position of the movable platform 114 is to control the robotic transfer means 112. Then, the workpiece 110 can be transported into the processing tool 102 and placed onto the movable platform 114 by the robotic transfer means 112. The sensor means 116 is for detecting whether the movable platform 114 of the processing tool 102 is in a selected condition such as position A, and producing an output. The sensor means 116 comprises a switch sensor for detecting whether the movable platform 114 is ready or not and all the circuits transferring the output to a control module 118. For example, the circuit of one side of the switch sensor is connected to the ground, and the other is connected to the control module. The control module 118 responsive to the output is to control the robotic transfer means 112 of the interface apparatus 101. It is noted that the control module 118 can be an external control for the robotic transfer means 112 or an internal control for the interface apparatus 101.

The key aspect of the present invention is the simplification of the operation interface by disabling the robotic transfer means 112 if the sensor means 116 detects that the movable platform 114 is not ready. In other words, when the movable platform 114 is not ready, the control module 118, responsive to the output, disables the load/unload function of the robotic transfer means 112. If the sensor means 116 detects that the movable platform 114 is ready, reaching the position A, the control module 118, responsive to the output, activates the load/unload function of the robotic transfer means 112. Thus an operator is unable to operate the robotic transfer means, and the processing tool and the interface apparatus are prevented from damage resulting in increasing equipment downtime. Additionally, the control module comprises a display module 124, such as a light indicator, indicating the ready/not ready status of the movable platform. When the movable platform is ready, the light indicator is on or illuminated, and when the movable platform is not ready, the light indicator is off, such that the operator can easily understand when a load/unload operation is required. Thus, the machine downtime caused by improper operation is reduced.

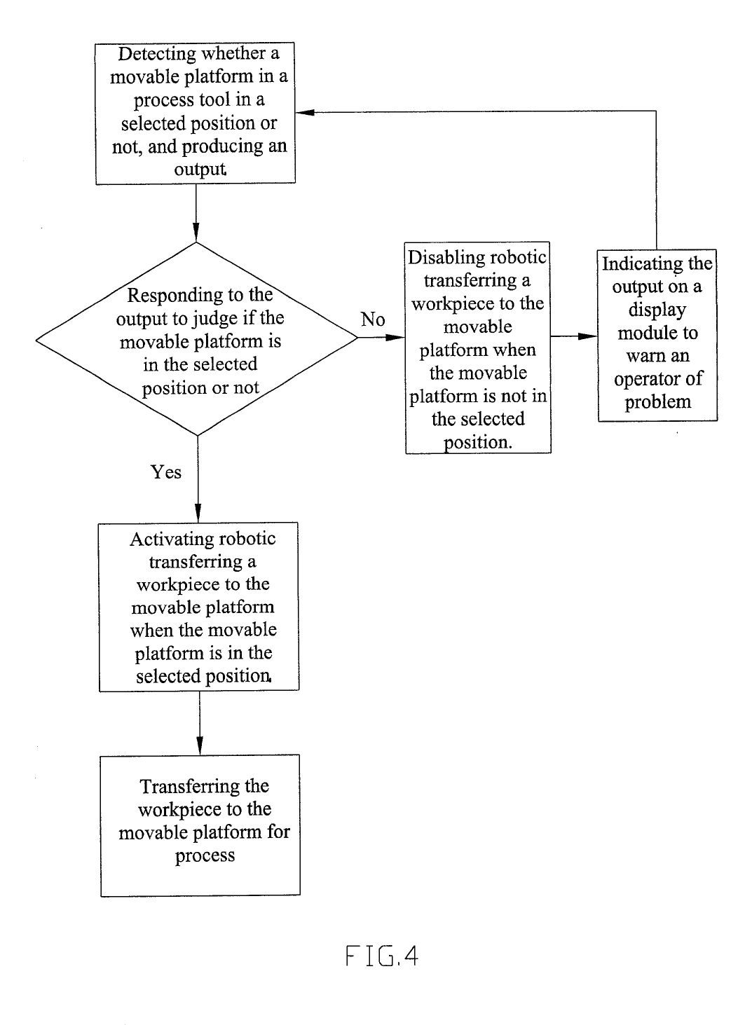

FIG. 4 illustrates a flowchart of the semiconductor apparatus. The sensor means is to detect whether the movable platform in the process tool in a selected position or not, and producing an output. Then, the output is responded to judge whether the movable platform in the selected position or not. Furthermore, the interface apparatus is disabled from robotic transferring a workpiece to the movable platform when the movable platform is not in the selected position. Simultaneously, the output is displayed on a display module. Simultaneously, the output is displayed on a display module. The interface apparatus is activated for robotic transferring a workpiece to the movable platform when the movable platform is in the selected position.

Generally, a SMIF system provides a single load/unload feature for transferring the workpiece. The single load/unload feature pertains to once a wafer lot is loaded to the processing tool, another wafer lot will be loaded to the processing tool only after the wafer lot is processed and unloaded. Incorporation of the single load/unload feature of the interface apparatus with the present invention, the operator can operate the semiconductor apparatus for transferring workpiece easily and an improper operation such as two wafer cassettes crashing into each other resulting in the damage of the processing tool and the interface apparatus and broken wafers can be avoided.

Although specific embodiments have been illustrated and described, it will be obvious to those skilled in the art that various modifications may be made without departing from what is intended to be limited solely by the appended claims.

What is claimed is:

1. A semiconductor apparatus for transferring workpiece with protection feature, said apparatus comprising:
a processing tool having a movable platform for supporting a workpiece;
an interface apparatus having a robotic transfer means to transfer said workpiece between said movable platform of said processing tool and said interface apparatus;
a sensor means for detecting whether said movable platform of said processing tool is in a selected condition, and producing an output; and
a control module responsive to said output to control said robotic transfer means.

2. The apparatus according to claim 1, wherein said workpiece comprises a semiconductor-wafer-carrying cassette.

3. The apparatus according to claim 1, wherein said interface apparatus comprises a standardized mechanical interface (SMIF) apparatus.

4. The apparatus according to claim 1, wherein said sensor means is a switch sensor.

5. The apparatus according to claim 1, wherein said control module disables said robotic transfer means if said output indicating said movable platform is not in said selected condition.

6. The apparatus according to claim 1, wherein said control module activates said robotic transfer means if said output indicating said movable platform is in said selected condition.

7. The apparatus according to claim 1, wherein said control module comprises a display module to indicate said selected condition.

8. The apparatus according to claim 7, wherein said display module comprises a light indicator.

9. A semiconductor apparatus for transferring workpiece with protection feature, said apparatus comprising:
a processing tool having a movable platform for supporting a workpiece;
a sensor means for detecting whether said movable platform is in a selected condition, and producing an output; and
a standardized mechanical interface (SMIF) apparatus having a robotic transfer means to transfer said workpiece between said movable platform and said standardized mechanical interface apparatus and a control module responsive to said output to control said robotic transfer means.

10. The apparatus according to claim 9, wherein said workpiece comprises a semiconductor-wafer-carrying cassette.

11. The apparatus according to claim 9, wherein said control module disables said robotic transfer means if said output indicating said movable platform is not in said selected condition.

12. The apparatus according to claim 9, wherein said control module activates said robotic transfer means if said output indicating said movable platform is in said selected condition.

13. The apparatus according to claim 9, wherein said control module comprises a light indicator to indicate said selected condition.
